(19) United States
(12) Patent Application Publication
(10) Pub. No.: US 2007/0031577 A1
(43) Pub. Date: Feb. 8, 2007

(54) Method for producing a soy protein product

(75) Inventors: Gitte Budolfsen, Frederiskberg (DK); Claus Crone Fuglsang, Veksoe (DK); Theodore M. Wong, Ballwin, MO (US); Phillip S. Kerr, Wildwood, MO (US)

Correspondence Address: NOVOZYMES NORTH AMERICA, INC., 500 FIFTH AVENUE, SUITE 1600, NEW YORK, NY, 10110, US

(73) Assignees: Novozymes A/S, Bagsvaerd (DK); Solae, LLC., St. Louis, MO (US)

(21) Appl. No.: 11/487,657

(22) Filed: Jul. 17, 2006

Related U.S. Application Data
(60) Provisional application No. 60/701,709, filed on Jul. 21, 2005.

(30) Foreign Application Priority Data
Jul. 20, 2005 (DK) PA 2005 01076

(51) Int. Cl. A23L 1/20

(52) U.S. Cl. 426/634

(57) ABSTRACT

The present invention relates to a method for producing a soy protein product by treatment of soy protein with at least one oxidoreductase.

### CROSS-REFERENCE TO RELATED APPLICATIONS

This application claims priority under 35 U.S.C. 119 of Danish application no. PA 2005 01076 filed Jul. 20, 2005 and the benefit under 35 U.S.C. 119 of U.S. provisional application No. 60/701,709 filed Jul. 21, 2005 the contents of which are fully incorporated herein by reference.

### TECHNICAL FIELD

The present invention relates to a method for producing a soy protein product by treating soy protein with an oxidoreductase.

### BACKGROUND OF THE INVENTION

Soy protein products, such as soy flour, soy protein concentrates and soy protein isolates, are used as ingredients in a large number of products, such as in food products. The functional properties of soy protein products are important for their quality as ingredients. Important functional properties are properties like water binding, ability to impart textural properties, flavour and taste. There is a need for soy protein products with improved functional properties, e.g. improved ability to impart textural properties such as viscosity to food products. Enzymatic processing of soy protein is known in the art. WO 97/43910 discloses a method for producing soy protein hydrolysates with excellent flavour by subjecting the soy protein to deamidation, for example enzymatic deamidation, and subjecting the soy protein to a specific acting proteolytic enzyme.

### SUMMARY OF THE INVENTION

The inventors have found that treating soy protein with at least one oxidoreductase results in a soy protein product with improved functional properties. Accordingly the present invention relates to a method for producing a soy protein product comprising treating soy protein with an oxidoreductase.

### DETAILED DISCLOSURE OF THE INVENTION

Oxidoreductases

An oxidoreductase may be any oxidoreductase described by the enzyme classification EC 1 as set out by the Nomenclature Committee of the International Union of Biochemistry and Molecular Biology (IUBMB), or any fragment derived therefrom exhibiting oxidoreductase activity. In one embodiment of the invention, an oxidoreductase is an oxidoreductase acting on diphenols and related substances as donors comprised by the enzyme classification EC 1.10, such as a laccase (EC 1.10.3.2), an o-aminophenol oxidase (EC 1.10.3.4), or a catechol oxidase (EC 1.10.3.1); or an oxidoreductase acting on CH—OH groups of donors described by the enzyme classification EC 1.1, such as a peroxidase, a glucose oxidase (EC 1.1.3.4), a hexose oxidase (EC 1.1.3.5), or a cellobiose oxidase (EC 1.1.3.25). In one embodiment of the invention, the soy protein is treated with a combination of two or more oxidoreductases, e.g. a combination of a peroxidase and a glucose oxidase (EC 1.1.3.4), a hexose oxidase (EC 1.1.3.5), or a cellobiose oxidase (EC 1.1.3.25). In a further embodiment of the invention, the oxidoreductase is a lipoxygenase (EC 1.13.11.12).

An oxidoreductase may be of any origin, e.g. of microbial origin. The enzyme may e.g. be derived from animals, plants, bacteria or fungi (including filamentous fungi and yeasts).

Suitable examples of fungal laccases include laccases derivable from a strain of Aspergillus, Neurospora, e.g., N. crassa, Podospora, Botrytis, Collybia, Fomes, Lentinus, Pleurotus, Trametes, e.g., T. villosa and T. versicolor, Rhizoctonia, e.g., R. solani, Coprinus, e.g., C. cinereus, C. comatus, C. friesii, and C. plicatilis, Psathyrella, e.g., P. condelleana, Panaeolus, e.g., P. papilionaceus, Myceliophthora, e.g., M. thermophila, Schytalidium, e.g., S. thermophilum, Polyporus, e.g., P. pinsitus, Phlebia, e.g., P. radita (WO 92/01046), or Coriolus, e.g., C. hirsutus (JP 2-238885).

Suitable examples of laccases from bacteria include a laccase derivable from a strain of Bacillus.

The oxidoreductase may furthermore be one which is producible by a method comprising cultivating a host cell transformed with a recombinant DNA vector which carries a DNA sequence encoding said oxidoreductase as well as DNA sequences encoding functions permitting the expression of the DNA sequence encoding the oxidoreductase, in a culture medium under conditions permitting the expression of the oxidoreductase enzyme, and recovering the oxidoreductase from the culture.

Determination of Laccase Activity (LACU)

Laccase activity (particularly suitable for Polyporus laccases) may be determined from the oxidation of syringaldazin under aerobic conditions. The violet colour produced is measured with a spectrophotometer at 530 nm. The analytical conditions are 19 mM syringaldazin, 23 mM acetate buffer, pH 5.5, 30° C., 1 min. reaction time.

1 laccase unit (LACU) is the amount of enzyme that catalyses the conversion of 1.0 micromole syringaldazin per minute at these conditions.

Determination of Laccase Activity (LAMU)

Laccase activity may be determined from the oxidation of syringaldazin under aerobic conditions. The violet colour produced is measured at 530 nm. The analytical conditions are 19 mM syringaldazin, 23 mM Tris/maleate buffer, pH 7.5, 30° C., 1 min. reaction time.

1 laccase unit (LAMU) is the amount of enzyme that catalyses the conversion of 1.0 micromole syringaldazin per minute at these conditions.

Source of Oxygen

The source of oxygen required by the oxidoreductase may be oxygen from the atmosphere or an oxygen precursor for in situ production of oxygen. Oxygen from the atmosphere will usually be present in sufficient quantity. If more O₂ is needed, additional oxygen may be added, e.g. as pressurized atmospheric air or as pure pressurized O₂.

Soy Protein

Soybeans belong to the legume family and contain on average 35-40% protein. Soy protein is made from dehulled, defatted soybean meal. The concentration of protein is achieved by removing most of the soluble non-protein compounds. These compounds are mainly soluble carbohydrates and some nitrogenous substances and minerals. This process removes much of the undesirable beany flavour as well as oligosaccharides (raffinose and stachyose). It is further contemplated that the whole soybeans used in the process of the present invention may be standard, commoditized soybeans, soybeans that have been genetically modified (GM) in some manner, or non-GM identity preserved soybeans.

The term “soy protein” typically refers to processed, edible, dry soybean products other than animal feed meals. Many types are produced for use in human and pet foods, milk replacers, and starter feeds for young animals. Soybean protein materials which are useful within the present invention are soy protein flour, soy protein concentrate, and soy protein isolate, or mixtures thereof.

The traditional processes for making the soy protein materials including soy protein flours, soy protein concentrates, and soy protein isolates all begin with the same initial steps. Soybeans entering a processing plant must be sound, mature, yellow soybeans. The soybeans can be washed to remove dirt and small stones. They are typically screened to remove damaged beans and foreign materials, and may be sorted to uniform size.

Each cleaned, raw soybean is then cracked into several pieces, typically six(6) to eight (8), to produce soy chips and hulls. The hulls are removed by aspiration. Alternatively, the hulls may be loosened by adjusting the moisture level and mildly heating the soybeans before cracking. Hulls can also be removed by passing cracked pieces through corrugated rolls revolving at different speeds. In these methods, the hulls are then removed by a combination of shaker screens and aspiration.

Soy chips, which contain about 11% moisture, are then conditioned at about 60° C. and flaked to about 0.25 millimeter thickness. The resulting flakes are then extracted with an inert solvent, such as a hydrocarbon solvent, typically hexane, in one of several types of countercurrent extraction systems to remove the soybean oil. Hexane extraction is basically an anhydrous process, as with a moisture content of only about 11%, there is very little water present in the soybeans to react with the protein. For soy protein flours, soy protein concentrates, and soy protein isolates, it is important that the flakes be desolventized in a manner which minimizes the amount of cooking or toasting of the soy protein to preserve a high content of water-soluble soy protein. This is typically accomplished by using vapour desolventizers or flash desolventizers. The flakes resulting from this process are generally referred to as “edible defatted flakes.” Specially designed extractors with self-cleaning, no-flake-breakage features, and the use of a narrow boiling range hexane are recommended for producing edible defatted flakes.

The resulting edible defatted flakes, which are the starting material for soy protein flour, soy protein concentrate, and soy protein isolate, have a protein content of approximately 50%. Moisture content has typically been reduced by three (3) to five (5)% during this process. Any residual solvent may be removed by heat and vacuum.

The soy protein flour, soy protein concentrate, and soy protein isolate are described below as containing a protein range based upon a “moisture free basis” (mfb).

The edible defatted flakes are then milled, usually in an open-loop grinding system, by a hammer mill, classifier mill, roller mill or impact pin mill first into grits, and with additional grinding, into soy flours with desired particle sizes. Screening is typically used to size the product to uniform particle size ranges, and can be accomplished with shaker screens or cylindrical centrifugal screeners.

Soy Protein Flour

Soy protein flour, as that term is used herein, refers to a comminuted form of defatted soybean material, preferably containing less than 1% oil and formed of particles having a size such that the particles can pass through a No. 100 mesh (U.S. Standard) screen. Soy protein flour has a soy protein content of about 50% to about 65% on a moisture free basis (mfb). Preferably the flour is very finely ground, most preferably so that less than about 1% of the flour is retained on a 300 mesh (U.S. Standard) screen. The remaining components are soy fiber material, fats, minerals, and sugars such as sucrose, raffinose and stachyose.

Soy Protein Concentrate

Soy protein concentrate, as the term is used herein, refers to a soy protein material containing from about 65% to less than about 90% of soy protein (mfb). The remaining components are soy fiber material, fats, minerals, and sugars such as sucrose, raffinose, and stachyose. Soy protein concentrates are prepared from dehulled and defatted soy flakes by removing most of the water-soluble, non-protein constituents. The “traditional method” for preparing soy protein concentrates is by aqueous alcohol leaching. In this method, edible defatted soy flakes are leached (washed) with alcohol and water. The alcohol and water is typically 60% to 90% ethanol, and removes much of the soluble sugars. The soluble sugars are separated from the wet flakes with the soluble sugars being used for some other purpose or discarded. The wet flakes are transferred to a desolventizer. Sufficient heat is used in the desolventizer to increase the vapor pressure of the alcohol and water to remove that liquid, but is sufficiently low enough to minimize cooking of the protein. The application of reduced pressures over the liquid bearing mass also increases the rate of removal of the liquid.

The remaining water and wet flakes are dried in a dryer to remove water and to produce a soy protein concentrate.

Secondary treatments such as high pressure homogenization or jet cooking can be used to restore some solubility lost during processing.

Another less used method for producing soy protein concentrates is by acid leaching. Edible defatted flakes and water are combined in a ratio of about 10:1 to 20:1 water to edible defatted flakes, with a food-grade acid (water plus acid) typically hydrochloric acid, to adjust the pH to about 4.5. The extraction typically runs for about 30 to 45 minutes at about 40° C. The acid-leached flakes are separated from the acid solubles to concentrate the solids to about 20%. A second leach and centrifugation may also be employed. The acid solubles are used for some other purpose or are discarded. The acidified wet flakes are neutralized to a pH of about 7.0 with alkali and water (e.g., sodium hydroxide or calcium hydroxide) to produce neutralized water and wet flakes. The neutralized water is separated from the wet flakes and the wet flakes are spray dried at about 157° C. inlet air temperature and about 86° C. outlet temperature to remove water and to produce soy protein concentrate. Soy protein concentrates are commercially available from Solae® LLC, for example, as Promine DSPC, Procon, Alpha 12 and Alpha 5800.

Soy protein concentrates are available in different forms, e.g. as granules or spray dried product.

Soy Protein Isolate

Soy protein isolate, as the term is used herein, refers to a soy protein material containing at least about 90% protein content (mfb). The remaining components are soy fiber material, fats, minerals, and sugars such as sucrose, raffinose, and stachyose. The edible defatted flakes are placed in an aqueous bath to provide a mixture having a pH of at least about 6.5 and preferably between about 7.0 and about 10.0 in order to extract the protein. Typically, if it is desired to elevate the pH above 6.7, various alkaline reagents such as sodium hydroxide, potassium hydroxide and calcium hydroxide or other commonly accepted food grade alkaline reagents may be employed to elevate the pH. A pH of above about 7.0 is generally preferred, since an alkaline extraction facilitates solubilization of the soy protein. Typically, the pH of the aqueous extract of soy protein will be at least about 6.5 and preferably about 7.0 to about 10.0. The ratio by weight of the aqueous extractant to the edible defatted flakes is usually between about 20:1 and preferably a ratio of about 10:1. Before continuing a work-up of the extract, the extract is centrifuged to remove insoluble carbohydrates. A second extraction is performed on the insoluble carbohydrates to remove any additional soy protein. The second extract is centrifuged to give any further insoluble carbohydrates and a second aqueous extract. The first and second extracts are combined for the work-up. The insoluble carbohydrates are used to obtain the soy fiber. In an alternative embodiment, the soy protein is extracted from the edible defatted flakes with water, that is, without a pH adjustment.

The extraction temperatures which may be employed can range from ambient up to about 49° C. (120° F.) with a preferred temperature of 32.2° C. (90° F.). The period of extraction is further non-limiting and a period of time between about 5 to about 120 minutes may be conveniently employed with a preferred time of about 30 minutes. Following extraction of the soy protein material, the aqueous extract of soy protein can be stored in a holding tank or suitable container while a second extraction is performed on the insoluble solids from the first aqueous extraction step. This improves the efficiency and yield of the extraction process by exhaustively extracting the soy protein from the residual solids from the first step.

The combined, aqueous soy protein extracts from both extraction steps, without the pH adjustment or having a pH of at least 6.5, or preferably about 7.0 to about 10, are then precipitated by adjustment of the pH of the extracts to, at or near the isoelectric point of the soy protein to form an insoluble curd precipitate. The pH to which the soy protein extracts are adjusted is typically between about 4.0 and about 5.0. The precipitation step may be conveniently carried out by the addition of a common food grade acidic reagent such as acetic acid, sulfuric acid, phosphoric acid, hydrochloric acid, or with any other suitable acidic reagent. The soy protein precipitates from the acidified extract, and is then separated from the extract. The separated soy protein may be washed with water to remove residual soluble carbohydrates and ash from the protein material and the residual acid can be neutralized to a pH of from about 4.0 to about 6.0 by the addition of a basic reagent such as sodium hydroxide or potassium hydroxide. At this point the soy protein material is subjected to a pasteurization step. The pasteurization step kills microorganisms that may be present. Pasteurization is carried out at a temperature of at least 82.2° C. (180° F.) for at least 10 seconds, at a temperature of at least 87.8° C. (190° F.) for at least 30 seconds or at a temperature of at least 90.6° C. (195° F.) for at least 60 seconds. The soy protein material is then dried using conventional drying means to form a soy protein isolate. Soy protein isolates are commercially available from Solae® LLC, for example, as SUPRO® 500E, SUPRO® PLUS 651, SUPRO® PLUS 675, SUPRO® 516, SUPRO® XT 40, SUPRO® 710, SUPRO® 720, FXP 950, FXP H0120 and PROPLUS 500F.

The soy protein material used in the present invention, may be modified to enhance the characteristics of the soy protein material. The modifications are modifications which are known in the art to improve the utility or characteristics of a protein material and include, but are not limited to, denaturation and hydrolysis of the protein material.

Treatment with Oxidoreductase

The soy protein to be treated may be in an aqueous suspension. An aqueous suspension may be prepared by mixing a soy protein preparation with water. Additional ingredients, such as salts, may be added depending on the desired properties of the final product. The pH and ionic strength of the aqueous suspension may be controlled to provide suitable conditions for the oxidoreductase enzyme to be active, depending on the desired properties of the final soy protein product. In one embodiment of the invention, an aqueous preparation of soy protein containing at least 50%, preferably at least 60%, more preferably at least 70%, and more preferably at least 80%, soy protein (weight/weight) in dry matter is treated with an oxidoreductase. In another embodiment, an aqueous suspension of soy protein concentrate and/or soy protein isolate is treated with an oxidoreductase.

The treatment with oxidoreductase may be effected by adding the oxidoreductase, as a dry product, a suspension, or a solution to an aqueous solution or suspension of soy protein. The oxidoreductase may be mixed into the solution or suspension of soy protein by any appropriate means known in the art. Additionally a mediator may be added. A mediator may be any substance suitable for enhancing the action of the oxidoreductase on the soy protein, such as tyrosine.

Treatment of soy protein with an oxidoreductase according to the invention may be performed in the presence of carbohydrates, lipids, hydrogen peroxide, other proteins, and mixtures thereof.

The temperature of the oxidoreductase treatment may be any temperature suitable for ensuring the activity of the specific oxidoreductase enzyme used. Typically, the range is between 5° C. and 100° C. The temperature may be chosen by the skilled person by methods well known in the art. In one embodiment of the invention, soy protein is treated with an oxidoreductase at a temperature between 5° C. and 100° C., preferably between 10° C. and 80° C., and more preferably between 50° C. and 70° C. Similarly the treatment of soy protein with an oxidoreductase may be performed at a pH chosen by methods known in the art depending on the specific enzyme and/or soy protein material. In one embodiment of the invention, soy protein is treated with an oxidoreductase at a pH between 2 and 10, preferably between 4 and 9, more preferably between 6 and 8. The duration of the treatment may be any duration suitable for obtaining the desired result. Typically, the duration of the treatment of soy protein with oxidoreductase is between 5 minutes and 5 hours. In one embodiment, the duration of the treatment of soy protein with an oxidoreductase is between 5 minutes and 5 hours, preferably between 10 minutes and 2 hours. The amount of oxidoreductase enzyme used may be chosen so as to achieve the desired result. Typically, the amount of oxidoreductase enzyme used is between 0.5 LAMU/g soy product and 4.0 LAMU/g soy product. The amount depends on the activity of the specific oxidoreductase towards the specific soy protein substrate, along with the temperature, duration, and other conditions of the oxidoreductase treatment.

In another embodiment of the invention, soy protein is treated with an amount of oxidoreductase and for a time sufficient to lead to an increase in water holding capacity of the treated soy protein preparation compared to similar untreated soy protein. Typically the soy protein is treated with between 0.5 LAMU/g soy product and 4.0 LAMU/g soy product of oxidoreductase for at least 30 minutes at a temperature of between 40° C. and 70° C., in order to increase the water holding capacity of the treated soy protein preparation.

In one embodiment the invention relates to use of at least one oxidoreductase to treat soy protein concentrate and/or soy protein isolate to increase the water holding capacity and/or water binding of the soy protein concentrate and/or soy protein isolate. In a further embodiment the invention relates to use of at least one oxidoreductase to treat soy protein concentrate and/or soy protein isolate to increase the viscosity of a solution or suspension of the soy protein concentrate and/or soy protein isolate.

Functional Properties of Soy Protein Preparation of the Invention

The soy protein preparation of the invention has improved properties compared to a similar soy protein product that has not been treated with an oxidoreductase. In one embodiment, the viscosity of a suspension of the soy protein preparation is higher than a similar suspension that has not been treated with an oxidoreductase. Typically the soy protein is treated with between 0.5 LAMU/g soy product and 4.0 LAMU/g soy product of oxidoreductase for at least 30 minutes at a temperature of between 40° C. and 70° C., in order to increase the viscocity of the treated soy protein preparation. Viscosity may be increased by at least 2%, preferably at least 3%, and more preferably at least 5%, compared to a similar soy protein product that has not been treated with an oxidoreductase. Viscosity may be measured by methods well known in the art, e.g. by rotary viscometry. In another embodiment, the taste of the soy protein preparation is improved. In still another embodiment, the water holding capacity of the soy protein preparation is increased compared to a similar soy protein preparation that has not been treated with an oxidoreductase. Inclusion of a soy protein preparation according to the invention in a food product may increase the water holding capacity of the food product compared to a similar food product comprising an equal amount of a similar soy protein preparation produced without treatment with an oxidoreductase. Water holding capacity is the ability of a material to hold its own and/or added water during the application of forces, pressing, and/or heating. Water holding capacity may be evaluated by measurement of viscosity, by the method furnished by AACC (American Association of Cereal Chemists) Technical Committee, as described in Cereal Foods World (1981) 26:291, and/or by the method described in the examples following hereafter. In one embodiment of the invention, the water binding of the soy protein product is improved by the treatment with an oxidoreductase. The amount of bound water may be determined by ¹HNMR as described by H. C. Bertram et al., J. Agric. Food Chem., 50, 824-829 (2002) and in the examples following hereafter.

Treatment of soy protein with oxidoreductase may lead to crosslinking of soy protein molecules, e.g. by formation of dityrosine.

Food Product

In one embodiment, the invention relates to a method for producing a food product comprising mixing a soy protein preparation of the invention with additional food ingredients and producing a food product from the mixture. A food product of the invention may be any food product, e.g. a meat product, a dairy product, a vegetable product, fruit product, a ready to eat product, and mixtures thereof. A food product of the invention may also be a component of a food used to impart desired form or structure, enhance texture, or improve convenience in use, e.g. an edible film, coating or casing.

Soy protein is well known in the art as an ingredient of or an additive to a number of different food products. A soy protein preparation according to the invention may be used as an ingredient in a food product in the same way as other soy protein products are usually used. A food product comprising a soy protein preparation according to the invention may be produced in the same manner as a food product comprising a conventional soy protein product. A soy protein preparation according to the invention may be added in the same way and in the same amounts as a conventional soy protein product is added to a similar food product.

A meat product according to the invention may be a whole meat product or a processed meat product, such as sausage, meat loaf, comminuted meat product, ground meat, bacon, polony, salami, or pate. A processed meat product may further comprise salts, spices, milk protein, vegetable ingredients, colouring agents, texturising agents, and mixtures thereof. A processed meat product may be an emulsified meat product, manufactured from a meat based emulsion. The meat based emulsion may be cooked or baked in a baking form or after being filled into casing of plastic, collagen, cellulose, or natural casing. A processed meat product may also be a restructured meat product, such as restructured ham. A meat product of the invention may undergo at least one of the following processing steps: curing, drying, smoking, fermentation, cooking, slicing, and/or shredding. A meat based food product may be produced by contacting meat with a soy protein preparation according to the invention and producing a meat based food product from the treated meat. The meat will usually be raw when being contacted with a soy protein preparation according to the invention, but may also be heat treated, precooked, or irradiated. The meat may also have been frozen before contact with a soy protein preparation according to the invention. Contacting meat with a soy protein preparation according to the invention may be done by adding a soy protein preparation according to the invention to meat. Contacting meat with a soy protein preparation according to the invention may be achieved by mixing meat, such as pieces of meat, minced meat, or a meat based emulsion, with a soy protein preparation according to the invention and, where applicable, other ingredients used to form the meat based food product by any method known in the art. Before contact with the meat, a soy protein preparation according to the invention may be mixed with other ingredients, to form a marinade or pickling liquid, such as water, salt, flour, milk protein, vegetable protein, starch, hydrolysed protein, phosphate, acid, spices, and mixtures thereof. The amount of a soy protein preparation according to the invention in a marinade may be adjusted as to achieve the desired final amount of a soy protein preparation according to the invention in the meat based food product. Contacting meat, such as whole animal muscle or pieces of animal muscle, with a soy protein preparation according to the invention may be achieved by marinating and/or tumbling and/or injecting the meat with a marinade comprising a soy protein preparation according to the invention. If the meat product is a processed meat product, such as an emulsified meat product, a soy protein preparation according to the invention may be mixed into a meat based emulsion, or into any other form of meat based mixture used to form the processed meat product.

A dairy product according to the invention may be skimmed milk, whole milk, cream, a fermented milk product, cheese, yoghurt, butter, dairy spread, butter milk, acidified milk drink, sour cream, whey based milk drink, ice cream, a flavoured milk drink, or a dessert product based on milk components such as vla or custard. A dairy product may additionally comprise non-milk components, such as vegetable components including vegetable oil, vegetable protein, vegetable carbohydrates, and mixtures thereof. Dairy products may also comprise further additives such as enzymes, flavouring agents, microbial cultures, salts, sweeteners, sugars, acids, fruit, fruit juices, any other component known in the art as a component of, or additive to a dairy product, and mixtures thereof.

### EXAMPLE 1

Materials

Soy protein concentrate A

Soy protein concentrate B

Soy protein isolate

Laccase (derived from a strain of Myceliophthora thermophila as disclosed in WO 95/33836)

Soy Samples

Three separate samples were run in which the 6% soy protein was Soy protein concentrate A in one sample, Soy protein concentrate B in a second sample, and Soy protein isolate in a third sample. Results appear in Table 1 below.

The 6% soy protein was suspended in water and allowed to hydrate at 5° C. over night and then treated with 0-0.5 LAMU/g laccase for 30 minutes at 60° C. (6° dH, pH 7.3) and subsequently heat treated for 10 minutes at 95° C.

Viscosity Measurement:

Viscosity was measured on a Rapid Visco Analyzer, model RVAA at 200 rpm for 2 minutes at 23° C. Triple determinations were made with 25 g of each sample suspension.

Precipitate Determination:

Centrifugation was carried out as follows: 10 min. at 3500 rpm, 20 ° C. in a Heraeus Sorvall multifuge 3 S-R. Amount of precipitate was determined by decanting and weighing the precipitate.

Results

TABLE 1

| | Laccase | Average | |
|---|---|---|---|
| | LAMU/g soy | viscosity | Precipitate |
| Soy sample | protein | cP | G |
| Soy protein concentrate A | 0 | 93 | |
| Soy protein concentrate A | 0.1 | 107 | |
| Soy protein concentrate A | 0.25 | 103 | |
| Soy protein concentrate A | 0.5 | 107 | |
| Soy protein concentrate B | 0 | 57 | 3.61 |
| Soy protein concentrate B | 0.1 | 60 | 3.95 |
| Soy protein concentrate B | 0.25 | 60 | 3.85 |
| Soy protein concentrate B | 0.5 | 61 | 3.93 |
| Soy protein isolate | 0 | 53 | 0.88 |
| Soy protein isolate | 0.1 | 53 | 1.02 |
| Soy protein isolate | 0.25 | 54 | 1.08 |
| Soy protein isolate | 0.5 | 57 | 1.28 |

### EXAMPLE 2

Materials:

Soy protein isolate (Supro® 500E, The Solae® Company)

Soy protein concentrate (Alpha 12TS, The Solae® Company)

Soy Flour (The Solae® Company)

8 g of soy product was dissolved in 92 g of distilled water by slow addition under magnetic stirring. Laccase was added to the dissolved soy product under magnetic stirring at 60° C. at a dose of 1.0 LAMU/g soy product, and samples were left for 30 minutes for enzymatic reaction and then heated to 90° C. for 10 minutes in a shaking water bath to inactivate the laccase. Control samples were treated in the same way except that no laccase was added.

Viscosity of the treated samples was measured as described in Example 1. Results are shown in Table 2.

TABLE 2
Viscosity (cP)

| Soy product | Control sample | Laccase treated sample |
|---|---|---|
| Soy protein isolate | 72 | 101 |
| Soy protein concentrate | 101 | 112 |
| White flakes | 38 | 41 |

### EXAMPLE 3

Materials:

Soy protein isolate (Supro® 500E, The Solae® Company)

Soy protein concentrate (Alpha 12TS, The Solae® Company)

Soy Flour (The Solae® Company)

4 g of soy product was dissolved in 59 g of distilled water by slow addition under magnetic stirring. Laccase was added to the dissolved soy product under magnetic stirring at 60° C. at a dose of 1.5 LAMU/g soy product, and samples were left for 30 minutes for enzymatic reaction and then heated to 90° C. for 5 minutes in a shaking water bath to inactivate the laccase. Control samples were treated in the same way except that no laccase was added.

Model sausages were produced by mixing 35 g of minced pork meat with maximum 12% fat with 2 g salt and 63 g of soy product solution at a temperature below 10° C. in a food processor. 4 g of the mixture was transferred to a NMR glass tube and heat treated at 90° C. for 5 minutes in a shaking water bath.

The amount of bound and free water was determined by low resolution ¹HNMR as described by H. C. Bertram et al., J. Agric. Food Chem., 50, 824-829 (2002). Relaxation time measurements were performed on a Maran Ultra ¹H 24 MHz (Resonance Instruments, UK) with 4095 echoes, TAU of 150 microseconds and relaxation delay of 4 seconds. The amount of bound water was determined as the area of the signal component denoted T21 by Bertram et. al with a relaxation time around 45 ms. Relaxation times were observed between 80 and 90 ms for soy protein concentrate and soy protein isolate and between 75 and 95 ms for white flakes, for the same component. The total amount of water was determined as the sum of the areas of all components.

The amount of bound water as percent of total water is shown in Table 3.

TABLE 3
Amount of bound water in percent of total water

| Soy product | Control sample | Laccase treated sample |
|---|---|---|
| Soy protein isolate | 53% | 55% |
| Soy protein concentrate | 62% | 70% |
| White flakes | 76% | 74% |

### EXAMPLE 4

Materials:

Soy protein concentrate (Alpha 12TS, The Solae® Company)

Model sausages were prepared as described in Example 3 with soy protein concentrate treated with varying amounts of laccase (0.5, 1.0, 1.5 and 4.0 LAMU/g soy protein concentrate) and the amount of bound water determined as described in example 3. The increase in amount of bound water compared to control sausages prepared with soy protein concentrate that was not treated with laccase is given in Table 4.

TABLE 4
Increase in amount of bound water compared to untreated control.

| LAMU Laccase pr. g soy | Increase in amount of bound |
|---|---|
| protein concentrate | water compared to control |
| 0.5 | 12% |
| 1.0 | 17% |
| 1.5 | 6% |
| 4.0 | 0% |

### EXAMPLE 5

Materials:

Soy protein concentrate

Samples were produced by dissolving soy protein concentrate to 12.50% Total Solids. Sodium hydroxide was used to adjust the pH to 7.2. After neutralization, the slurry was heated to 153.3° C. (308° F.) and held at this temperature for 15 seconds and then cooled to 54° C. (129° F.).

Laccase was added in various amounts (0.435, 0.869 and 1.736 LAMU/g soy protein concentrate) under stirring at a temperature of 50° C. (122° F.) and allowed to react at this temperature for 30 minutes. After the enzyme reaction the sample was heated to 151.7° C. (305° F.) for 10-15 seconds. The sample was spray dried and the product was collected for use and analysis. Control samples were prepared in the same way except that no enzyme was added.

Detection of Dityrosine

Dityrosine is a well characterized protein oxidation product from biological systems, it is acid stable and can be detected upon acid hydrolysis by HPLC separation followed by fluorescence detection. Dityrosine was measured as a measure of the degree of cross-binding as a result of the laccase treatment.

50 mg freeze dried samples were mixed with 2 mL 6 M HCl, flushed with nitrogen and hydrolyzed over night at 105° C. Subsequently, the samples neutralized by 6 M NaOH and filtered through 0.45 micrometer filters. Twenty microliters of the hydrolyzed sample was injected onto a HPLC column (Nucleosil 120-5, C-18, 250×4 mm, Macherey-Nagel, Duren, Dûren, Germany), which was equilibrated with 4% acetonitrile in aqueous 0.1 M citric acid (pH 2.55) with a flow of 1 mL/min as described by Daneshvar et al. (Daneshvar, B; Frandsen, H.; Dragsted, L. O.; Knudsen, L. E. and Autrup, H. (1997). Analysis of native human plasma proteins and haemoglobin for the presence of bityrosine by high-performance liquid chromatography. Pharmacol. Toxicol. 81, 205-208). Chromatographic separation was performed on a Varian 9012 HPLC pump, connected to a Varian 9100 Auto sampler and a Varian 9075 Fluorescence detector (Varian Chromatographic Systems, Walnut Creek, Calif.). Dityrosine was quantified using a standard curve made by the use of a dityrosine standard prepared according to Nomura et al. (Nomura, K.; Suzuki, N. and Shigenibou, M. (1990). Pulcherosine, a novel tyrosine-derived trivalent cross-linking amino acid from the fertilization envelope of sea urchin embryo. Biochemistry, 29, 4525-4534).

Water Holding Capacity of Sausages

Sausages were prepared with the treated soy protein concentrate from the following ingredients:

| | |
|---|---|
| Pork Trim 80/20 | 16.80% |
| Pork Back Fat 05/95 | 15.66% |
| Skin Emulsion | 10.00% |
| Chicken MDM | 20.00% |
| Ice/Water | 28.66% |
| Soy Protein Concentrate | 4.00% |
| Potato Starch | 2.00% |
| Salt | 1.70% |
| Spices | 1.18% |

Pork trim and pork back fat were ground before use and all meat was stored at 4° C. before use. All ingredients were mixed and chopped for 1-3 minutes and filled into cellulose casings. The meat was equilibrated for 10 min. at 35.6° C. (96° F.), smothered for 15 min total at 43.3° C. (110° F.) with steam and heated to 65.6° C. (150° F.) (dry heat). Sausages were cooked without smoking for a total of 20 min at 60° C. (140° F.) with steam, and then at 77.8° C. (172° F.) (dry heat).

Calculation of Water Holding Capacity (WHC)

The application samples were subjected to analysis using a TA-HDI Texture Analyzer from Texture Technologies Corporation, Scarsdale, N.Y. The texture analyzer generated a graph of the force used for compression as a function of time. Samples were compressed twice to generate two peaks in the graph. The program on the Texture Analyzer that is run for WHC is a 2-cycle TPA (Texture Profile Analysis). The test parameters are 4 inch diameter flat plate probe, 2 millimeters per second probe speed having a 75% compression.

Hardness was determined as the maximum force during the first compression.

The following parameters were defined according to Bourne M. C. 1978, Texture Profile Analysis. Food Technology, 32 (7), 62-66, 72.:

Chewiness=(Gumminess×Springiness).

Gumminess=(Hardness×Cohesiveness).

Cohesiveness=(Area under second peak/Area under first peak)

Springiness=(time from beginning of second peak to the top of second peak/time from beginning of first peak to top of first peak)

Hardness and Chewiness were determined for each sample at hot and cold temperatures. The cold temperature was defined as room temperature, and hot temperature was achieved by soaking of the samples in 100° C. water bath for 34 minutes.

For two standard samples, Cold Hardness data was plotted on the y-axis and assigned WHC on the x-axis. The standards was assigned WHC of 5.0 and 6.5, respectively (arbitrary units). These two points are connected by a curve of the equation y=m×n, where y is hardness, x is WHC, and m and n are found by regression This equation was then used to calculate WHC based on cold hardness for all the samples. This type of calculation was repeated to obtain WHC from Hot Hardness, Cold Chewiness, and Hot Chewiness data. These four WHC values were then averaged for each sample to determine the Overall Water Holding Capacity. Relative comparisons can be made between WHC values for experimental samples and appropriate controls.

Results

The amount of dityrosine of treated soy protein concentrate and control as well as the increase in Water Holding Capacity of sausages produced with the soy protein concentrate as compared to control sausages (produced with soy protein concentrate not treated with laccase) is shown in Table 5.

TABLE 5
Amount of dityrosine of treated soy protein concentrate
and control samples; and increase in Water Holding Capacity
of sausages produced with the soy protein concentrate
as compared to control sausages (produced with soy protein
concentrate not treated with laccase).

| | | Increase in Water |
|---|---|---|
| Laccase | Dityrosine | Holding Capacity compared |
| LAMU/g substrate | (mmol/g) | to control (%) |
| 0 (Control) | 25 | 0 |
| 0.435 | 35 | 5.8 |
| 0.869 | 37 | 7.7 |
| 1.736 | 40 | 16.8 |

### EXAMPLE 6

Samples were produced by dissolving soy protein concentrate to 12% Total Solids. Sodium hydroxide was used to adjust the pH to 7.1. After neutralization, the slurry was heated to 50° C. (122° F.) and laccase was added in an amount of 0.75 LAMU/g soy protein under stirring at a temperature of 50° C. (122° F.) and allowed to react at this temperature for 30 minutes. After the enzyme reaction the sample was heated to 151.7° C. (305° F.) for 10-15 seconds. The sample was spray dried and the product was collected for use and analysis. Control samples were prepared in the same way except that inactivated enzyme was added.

Determination of Molecular Weight Distribution

The molecular weight distribution was determined by size exclusion chromatography using a Supelc® TSK gel 300×7.8 mm column followed by a Micra-Synchopak SPCG-PEP 30 300×7.8 mm column mounted on a Hewlett-Packard Series 1050 HPLC system equipped with a UV/Vis detector operating at 260 and 280 nm. The mobile phase was a phosphate buffer containing 6 M GuanidineHCL with pH 7.6. Samples were dissolved in the mobile phase before injection. As molecular weight standards were used: Hexanal, DNA, alpha-chymotrypsin, Bovines serum albumin, myoglobulin, aprotin, ovalbumin and cytochrome C. Table 6 shows the absorption at 280 nm as a function of the molecular weight corresponding to the elution time.

Water Holding Capacity was determined as described in example 5. The laccase treated sample had 12% higher water holding capacity than the control sample.

TABLE 6
Molecular weight distribution determined by size exclusion HPLC

| | Molecular weight distribution determined | |
|---|---|---|
| Molecular | from absorbance at 280 nm (%) | |
| Weight (Da) | Control | Laccase treated |
| 85936-100000* | 11.9 | 12.2 |
| 69120-85936 | 12.7 | 13.3 |
| 52304-69120 | 11.0 | 11.7 |
| 34185-52304 | 8.6 | 9.3 |
| 20409-34185 | 6.2 | 6.9 |
| 12279-20409 | 5.2 | 6.0 |
| 7970-12279 | 3.4 | 3.9 |
| 7239-7970 | 2.6 | 3.2 |
| 6895-7239 | 2.0 | 2.7 |
| 6538-6895 | 1.9 | 2.9 |
| 5541-6538 | 2.7 | 3.4 |
| 4544-5541 | 4.8 | 4.1 |
| 3547-4544 | 6.9 | 5.0 |
| 1831-3547 | 7.0 | 5.0 |
| 450-1831 | 6.7 | 5.0 |
| <450 | 6.4 | 5.4 |
| Average Molecular weight: | 24,370 | 37,399 |

*estimated upper value

1. A method for producing a soy protein product comprising treating soy protein with at least one oxidoreductase.

2. The method of claim 1 comprising adding oxidoreductase to a solution or suspension of soy protein.

3. The method of claim 1 comprising treating soy flour with at least one oxidoreductase.

4. The method of claim 1 comprising treating soy protein isolate with at least one oxidoreductase.

5. The method of claim 1 comprising treating soy protein concentrate with at least one oxidoreductase.

6. The method of claim 1 comprising adding oxidoreductase to a solution or suspension of soy protein containing at least 50% (weight/weight) soy protein in dry matter.

7. The method of claim 1 wherein at least one oxidoreductase is added in an amount sufficient to increase the viscosity of a solution or suspension of the soy protein.

8. The method of claim 1 wherein at least one oxidoreductase is added in an amount sufficient to increase the water holding capacity and/or water binding of a solution or suspension of the soy protein.

9. The method of claim 1 further comprising heating the treated soy protein to a temperature and for a time sufficient to inactivate the oxidoreductase.

10. The method of claim 1 wherein the oxidoreductase is a laccase.

11. The method of claim 1 further comprising preparing a food product with the treated soy protein.

12. A soy protein product produced by the method of claim 1.

13-14. (canceled)

15. The method of claim 11 wherein the food product is selected from the group consisting of a meat product, a dairy product, a vegetable product, a fruit product, a ready to eat product, and mixtures thereof.

16. The method of claim 15 wherein the meat product is selected from the group consisting of a whole meat product and a processed meat product.

17. The method of claim 16 wherein the processed meat product is selected from the group consisting of sausages, meat loaf, comminuted meat product, ground meat, bacon, polony, salami, pate, an emulsified meat product, and a restructured meat product.

18. The method of claim 15 wherein the dairy product is selected from the group consisting of skimmed milk, whole milk, cream, a fermented milk product, cheese, yoghurt, butter, dairy spread, buttermilk, acidified milk drink, sour cream, whey based milk drink, ice cream, a flavoured milk drink, via, custard, other dessert products based on milk components, and mixtures thereof.
